(19) United States
(12) Patent Application Publication
(10) Pub. No.: US 2021/0178415 A1
(43) Pub. Date: Jun. 17, 2021

(54) VALVE BODY ASSEMBY, WATER TANK, SPRAY SYSTEM, AND UNMANNED AERIAL VEHICLE

(71) Applicant: SZ DJI TECHNOLOGY CO., LTD., Shenzhen (CN)

(72) Inventors: Wanren ZHOU, Shenzhen (CN); Le ZHOU, Shenzhen (CN); Zhan SHU, Shenzhen (CN)

(73) Assignee: SZ DJI TECHNOLOGY CO., LTD., Shenzhen (CN)

(21) Appl. No.: 17/184,596

(22) Filed: Feb. 25, 2021

Related U.S. Application Data
(63) Continuation of application No. PCT/CN2019/103859, filed on Aug. 30, 2019.

(51) Int. Cl. B05B 12/08; B64C 39/02; B64D 1/18

(52) U.S. Cl. CPC B05B 12/08; B64C 39/024; A01G 25/09; B64C 2201/12; B64D 1/18

(57) ABSTRACT

The present disclosure relates to a valve body assembly. The valve body assembly may include a valve body and a valve base. The valve body may include a housing, a valve core, and a first fluid channel. The valve base may include a driving portion and a second fluid channel. A bottom of the housing may include an opening. The valve core may be configured to move relative to the housing to seal the opening in a separated state or open the opening in a docked state.

### CROSS REFERENCE TO RELATED APPLICATION

The present application is a continuation of International Application No. PCT/CN2019/103859, filed on Aug. 30, 2019, the entire contents of which being incorporated herein by reference in its entirety.

### TECHNICAL FIELD

The present disclosure relates to the technical field of agricultural spraying, in particular, to a water tank, a valve body assembly, a spraying system and an unmanned aerial vehicle.

### BACKGROUND

With the development of society, the application fields of unmanned aerial vehicles have become wider and wider. For example, the use of unmanned aerial vehicles for agricultural plant protection has become more and more common.

When using unmanned aerial vehicles to spray crops, in order to improve efficiency, a quick-release water tank is used in most cases. The water tank is usually connected to the body of the unmanned aerial vehicle in a quick-release mode. In addition, in order to ensure sealing of the water tank during storage of water and connection with other pipelines during operation, a one-way valve is usually installed at the outlet of the quick-release water tank. Before the quick-release water tank is installed on the body of the UAV, the one-way valve is in a closed state to ensure sealing of the water tank. When the quick-release water tank is installed on the body of the UAV, the one-way valve on the water tank is docked with a one-way valve base on the body of the UAV. At this time, the one-way valve is opened, and the water tank is connected to the pipelines of the spray system.

However, during the docking of the one-way valve and the one-way valve base, gas that cannot be discharged will be brought in. The gas needs to be discharged through the water pump of the spray system. This will reduce the initial working pressure of the entire spray system. When the spraying system requires a larger load, the more the trapped gas, the smaller the suction capacity of the pump. It may even occur that the water pump cannot suction water and the spray system cannot spray water.

### SUMMARY

One embodiment of the present disclosure provides a valve body assembly. The valve body assembly may include a valve body comprising a housing, a valve core, and a first fluid channel; and a valve base comprising a driving portion and a second fluid channel. An opening is at a bottom of the housing, and the valve core is configured to move relative to the housing to seal the opening in a separated state or open the opening in a docked state.

Optionally, the valve body is configured to be inserted downwardly into the valve base so that the valve body and the valve base are in the docked state.

Optionally, in the docked state, the driving portion is configured to press against the valve core so that the valve core opens the opening, thereby connecting the first fluid channel and the second fluid channel.

Optionally, the valve core is slidably arranged in the housing, and a sliding direction of the valve core is the same as a direction of force on the valve core applied by the driving portion.

Optionally, a valve core mounting portion is fixed in the housing, and the valve core mounting portion comprises a guide channel for the valve core to be slidably arranged in the housing.

Optionally, a top of the valve core or a bottom of the valve core is provided with a sliding limit portion, the sliding limit portion is configured to cooperate with an edge of the guide channel of the valve core mounting portion to limit an extreme sliding position of the valve core.

Optionally, a top of the valve core is provided with an elastic expansion portion capable of expanding and contracting in a radial direction of the valve core, and a radial dimension of the elastic expansion portion after contraction is smaller than a radial dimension of the guide channel.

Optionally, the elastic expansion portion at the top of the valve core comprises at least a first section and a second section, each extending along a length direction of the valve core, and a spacing between the first section and the second section.

Optionally, the valve body assembly further include an opening sealing member on an outer side wall near a bottom of the valve core and/or on an inner side wall of the opening; wherein in the separated state, the valve core is inserted into the opening to squeeze the opening sealing member to seal the opening.

Optionally, the opening comprises a reaming section, and a diameter of an aperture of the reaming section gradually increases from a bottom of the reaming section to a top of the reaming section, and in the separated state, the opening sealing member is squeezed between the reaming section and the outer side wall near the bottom of the valve core.

Optionally, the opening sealing member comprises a fixing portion and a squeezing portion, the fixing portion is fixed on one of the outer side wall near the bottom of the valve core or the inner side wall of the opening, the squeezing portion is configured to have squeezing contact with the other one of the outer side wall near the bottom of the valve core or the inner side wall of the opening, and an outer profile of a cross section of the squeezing portion in a plane parallel to a length direction of the valve core is a curved surface.

Optionally, the valve body is also provided with a reset elastic member, and the reset elastic member is configured to drive the valve core to slide toward the opening to seal the opening in the separated state.

Optionally, the reset elastic member is sleeved on an outer side wall of the valve core or located beside the valve core, and an expansion and contraction direction of the reset elastic member is the same as a sliding direction of the valve core.

Optionally, the housing includes an upper housing and a lower housing, and the upper housing is detachably connected with the lower housing.

Optionally, an upper and lower housing sealing member is between the upper housing and the lower housing, and the upper and lower housing sealing member is configured to at least axially seal the upper housing and the lower housing.

Optionally, the valve base is provided with an accommodation cavity for accommodating the valve body, and in the docked state, the valve body is inserted into the accommodation cavity.

Optionally, an outer side wall of the housing of the valve body or an inner cavity wall of the accommodating cavity is provided with a valve body sealing member, and in the docked state, the outer side wall of the housing of the valve body and the inner cavity wall of the accommodating cavity are axially sealed by the valve body sealing member.

One embodiment of the present disclosure is a water tank. The water tank may include a tank body, a valve body on the tank body, and a valve base. The valve body includes a housing, a valve core, and a first fluid channel in the housing; an opening at a bottom of the housing, and the valve core is configured to move relative to the housing to seal the opening in a separated state or open the opening in a docked state. The valve base includes a driving portion and a second fluid channel.

Optionally, in the docked state, the driving portion is configured to press against the valve core so that the valve core opens the opening, thereby connecting the first fluid channel and the second fluid channel.

One embodiment of the present disclosure is an unmanned aerial vehicle. The unmanned aerial vehicle may include a main body and a valve base on the main body. The valve base is configured to dock with a valve body of a water tank. The valve body may include a housing, a valve core, and a first fluid channel in the housing; an opening at a bottom of the housing, and the valve core is configured to move relative to the housing to seal or open the opening. The valve base may include a driving portion and a second fluid channel. In a separated state, the valve core is configured to seal the opening. In a docked state, the driving portion is configured to press against the valve core so that the valve core opens the opening, thereby connecting the first fluid channel and the second fluid channel.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a perspective view of a valve body and a valve base of a valve body assembly in a separated state provided by an embodiment of the present disclosure;

FIG. 2 is a front view of a valve body and a valve base of a valve body assembly in a separated state provided by an embodiment of the present disclosure;

FIG. 3 is a cross-sectional view of a valve body and a valve base of a valve body assembly in a separated state provided by an embodiment of the present disclosure;

FIG. 4 is a perspective view of a valve body and a valve base of a valve body assembly in a docked state provided by the embodiment of the present disclosure;

FIG. 5 is a front view of a valve body and a valve base of a valve body assembly in a docked state provided by an embodiment of the present disclosure;

FIG. 6 is a cross-sectional view of a valve body and a valve base of a valve body assembly in a docked state provided by an embodiment of the present disclosure;

FIG. 7 is a schematic structural diagram of a water tank provided by an embodiment of the present disclosure;

FIG. 8 is a cross-sectional view of a water tank provided by an embodiment of the present disclosure; and

FIG. 9 is an enlarged view of A in FIG. 8.

### DETAILED DESCRIPTION

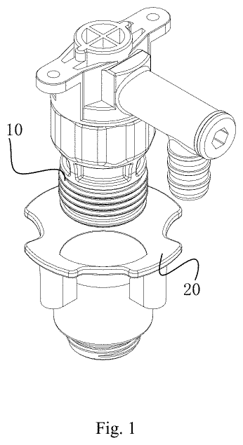

The specific embodiments of the present disclosure are further described in detail below with reference to the drawings and embodiments. The following examples are intended to illustrate the disclosure but are not intended to limit the scope of the disclosure. It should be noted that, in the case of no conflict, the features in the embodiments and the embodiments in the present application could be arbitrarily combined with each other. Throughout the description of the disclosure, reference is made to FIGS. 1-9. When referring to the figures, like structures and elements shown throughout are indicated with like reference numerals. It should be understood that the dimensions of the various parts shown in the drawings are not drawn in the actual scale. Based on these embodiments of the present disclosure, all other embodiments obtained by those of ordinary skill in the art without creative work shall fall within the protection scope of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

Unless otherwise defined, all technical and scientific terms used herein have the same meaning as commonly understood by those of ordinary skill in the technical field of the present disclosure. The terms used in the specification of the present disclosure herein are only for the purpose of describing specific embodiments, and are not intended to limit the present disclosure.

The term “comprising” mentioned in the entire specification and claims is an open term, so it should be interpreted as “including but not limited to.” “Approximately” means that within an acceptable error range, those of ordinary skill in the art can solve the technical problem and basically achieve the technical effect within the certain error range.

In addition, the term “connected” or “coupled” herein includes any direct or indirect means of connection. Therefore, if it is described that a first device is connected or coupled to a second device, it means that the first device can be directly connected or coupled to the second device, or indirectly connected or coupled to the second device through other devices.

The term “and/or” used in this specification describes only an association relationship of the associated objects, which indicates that there can be three relationships. For example, the term “A1 and/or B1” may indicate three scenarios, that is, A1 existing alone, A1 and B1 existing simultaneously, and B1 existing alone. In addition, the character “/” in this text generally indicates that the associated objects before and after are in an “or” relationship.

In the description of the present disclosure, the terms “center,” “horizontal,” “vertical,” “length,” “upper,” “lower,” “front,” “back,” “vertical,” “horizontal,” “top,” “bottom,” “inner,” “outer,” “an axial direction,” “a radial direction,” “a circumferential direction,” “up,” “down,” or the like are based on the orientation or positional relationship shown in the drawings. They are used merely for convenience of description and simplifying description of the present invention, but not to indicate or imply that the indicated apparatus or element must have a specific orientation, or be constructed and operated in a specific orientation, therefore cannot be construed as a limitation of the present disclosure.

In addition, the terms “first” and “second” are for illustration purposes only and are not to be construed as indicating or implying relative importance or implied reference to the quantity of indicated technical features. Thus, features defined by the terms “first” and “second” may explicitly or implicitly include one or more of the features. In the description of the present disclosure, the meaning of “plural” is two or more unless otherwise specifically and specifically defined.

In the description of the specification, references made to the term “one embodiment,” “some embodiments,” and “exemplary embodiments,” “example,” and “specific example,” or “some examples” and the like are intended to refer that specific features and structures, materials or characteristics described in connection with the embodiment or example that are included in at least some embodiments or example of the present disclosure. The schematic expression of the terms does not necessarily refer to the same embodiment or example. Moreover, the specific features, structures, materials or characteristics described may be included in any suitable manner in any one or more embodiments or examples.

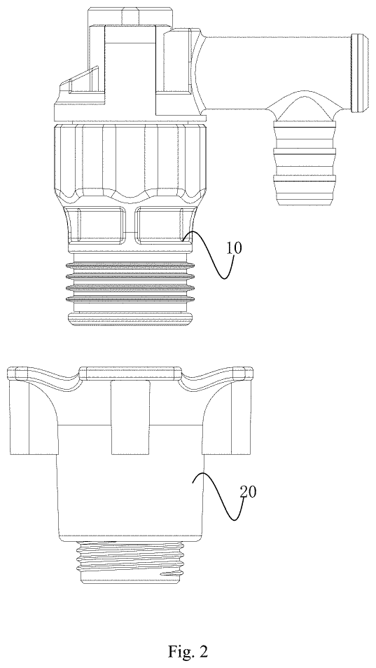

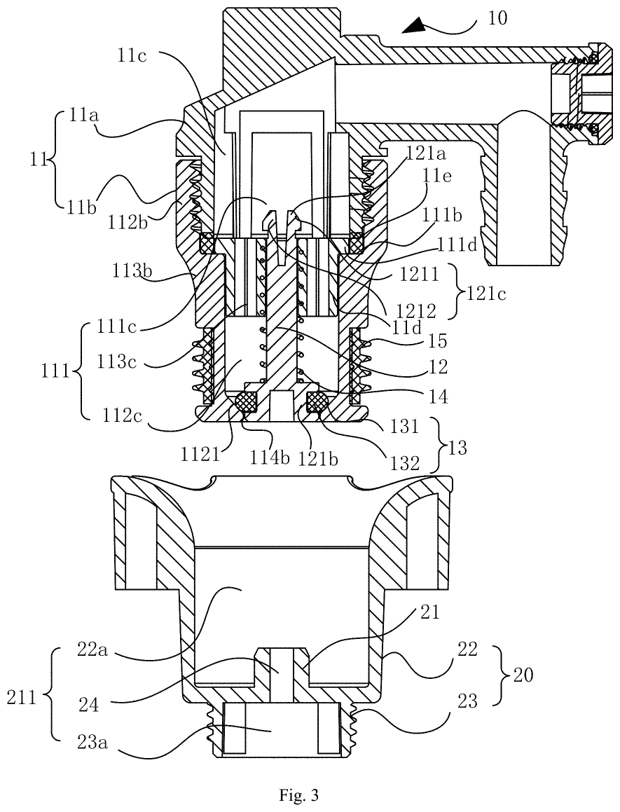

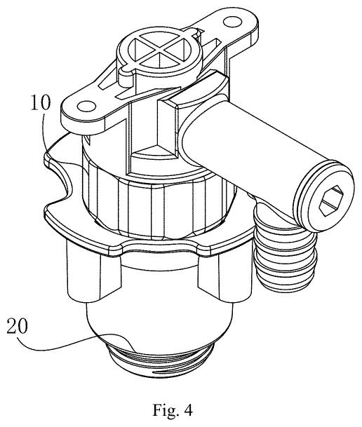

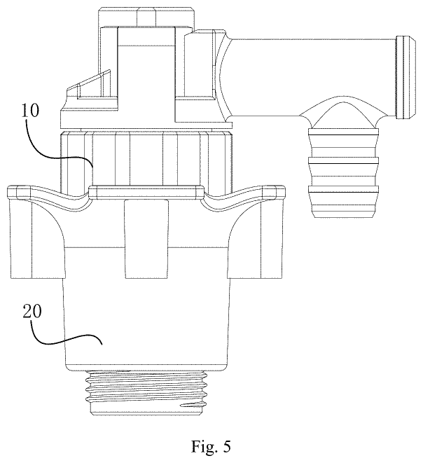

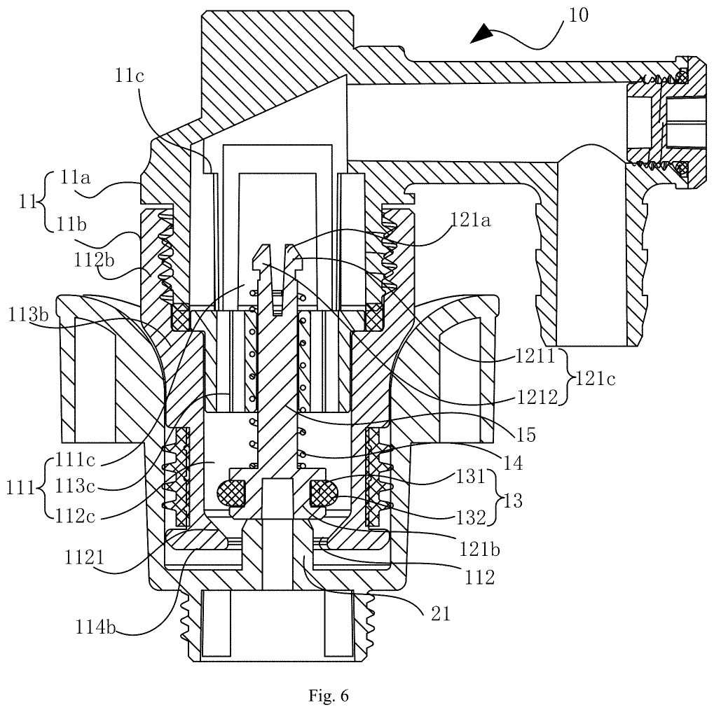

FIG. 1 is a perspective view of a valve body and a valve base of a valve body assembly in a separated state provided by an embodiment of the present disclosure. FIG. 2 is a front view of a valve body and a valve base of a valve body assembly in a separated state provided by an embodiment of the present disclosure. FIG. 3 is a cross-sectional view of a valve body and a valve base of a valve body assembly in a separated state provided by an embodiment of the present disclosure. FIG. 4 is a perspective view of a valve body and a valve base of a valve body assembly in a docked state provided by an embodiment of the present disclosure. FIG. 5 is a front view of a valve body and a valve base of a valve body assembly in a docked state provided by the embodiment of the present disclosure. FIG. 6 is a cross-sectional view of a valve body and a valve base of a valve body assembly in a docked state provided by the embodiment of the present disclosure.

Please refer to FIG. 1 to FIG. 6. One embodiment of the present disclosure provides a valve body assembly, which includes a valve body 10 and a valve base 20. The relative state of the valve body 10 and the valve base 20 includes a docked state and a separated state. The valve body 10 can be used to connect with the water tank, and the valve base 20 can be installed on an external equipment. The external equipment may refer to a frame of an unmanned aerial vehicle or other equipment that can be used to carry the spraying system. The valve base 20 may be specifically connected to a spraying system, for example, connected to a water pump of the spraying system through a pipeline.

In one embodiment, as shown in FIG. 3, the valve body 10 includes a housing 11 and a valve core 12. A first fluid channel 111 is formed in the housing 11. The valve core 12 is movably arranged in the housing 11, and the bottom of the housing 11 has an opening 112. The valve core 12 can move relative to the housing 11 to seal or open the opening 112. The valve base 20 is provided with a driving portion 21, and a second fluid channel 211 is formed in the valve base 20. In a docked state, the driving portion 21 presses against the valve core 12 to make the valve core 12 open the opening 112. As such, the first fluid channel 111 is connected with the second fluid channel 211. In a separated state, the valve core 12 seals the opening 112.

Optionally, the housing 11 of the valve body 10 may include an upper housing 11a and a lower housing 11b. The upper housing 11a and the lower housing 11b enclose a cavity 11c. The upper housing 11a and the lower housing 11b can be detachably connected. In one embodiment, the upper housing 11a and the lower housing 11b are screwed together. That is, the upper housing 11a has external threads, the lower housing 11b has internal threads, and the upper housing 11a may be inserted into the lower housing 11b and screwed together. Of course, the reverse is also possible, with internal threads on the upper housing 11a and external threads on the lower housing 11b, and the lower housing 11b may be inserted into the upper housing 11a and screwed together. In these embodiments, the upper housing 11a and the lower housing 11b are detachably connected. Such design may facilitate removal of the valve core 12, for example, for installation and maintenance of the valve core 12.

Optionally, in the cavity 11c of the housing 11, there is provided a valve core mounting portion 11d for mounting the valve core 12. The valve core mounting portion 11d can be fixed in the housing 11. Furthermore, the valve core mounting portion 12 can be provided with a guide channel for the valve core 12 to slide so that the valve core 12 can slide in a predetermined direction. The inner side wall of the lower housing 11b is provided with a support platform 111b protruding toward the inside of the housing 11b for supporting the valve core mounting portion 11d. The valve core mounting portion 11d is provided with an outwardly projecting flange 111d supported on the support platform 111b. The flange 111d is supported on the support platform 111b to support the valve core mounting portion 11d on the housing 11. The valve core mounting portion 11d may be fixed in the housing 11 in an interference fit manner or with fasteners.

Optionally, the valve core mounting portion 11d can divide the cavity 11c into an upper cavity 111c and a lower cavity 112c. The valve core mounting portion 11d is also provided a valve body connection channel 113c for connecting the upper cavity 111c and the lower cavity 112c. The upper cavity 111c, the valve body connection channel 113c, and the lower cavity 112c form the first fluid channel 111.

Optionally, between the upper housing 11a and the lower housing 11b is provided an upper and lower housing sealing member 11e for at least axially sealing the gap between the upper housing 11a and the lower housing 11b. In one embodiment, the upper and lower housing sealing member 11e can be squeezed between the bottom end of the side wall of the upper housing 11a and the support platform 111b. When the upper housing 11a is inserted into the lower housing 11b and is tightened by the thread between the upper housing 11a and the lower housing 11b, the bottom end of the side wall of the upper housing 11a exerts a resisting force on the upper and lower housing sealing member 11e. As such, the upper and lower housing sealing member 11e is elastically deformed and fully seals the gap between the upper housing 11a and the lower housing 11b, thereby preventing liquid from flowing into the gap between the upper housing 11a and the lower housing 11b.

Optionally, the valve core 12 can be slidably arranged in the housing 11. In one embodiment, the valve core 12 can be arranged in the valve core mounting portion 11d, and can be raised and lowered in the valve core mounting portion 11d. Of course, the valve core 12 is not limited to moving up and down in the vertical direction. The valve core 12 can also be moved in other ways in the valve core mounting portion 11d as long as the valve core 12 can block and open the opening 112, which is not limited in this embodiment. For example, the valve core 12 can be installed in the housing 11 laterally or diagonally, and move along the lateral or diagonal direction. In one embodiment, for convenience of processing and design, the movement direction of the valve core 12 can be restricted to up and down.

Optionally, the lower housing 11b may include a first side wall 112b for connecting with the upper housing 11a, a second side wall 113b for docking with the valve base 20, and a bottom wall 114b at the bottom of the lower housing 11b connected between the second side walls 113b. The bottom wall 114b may have an opening 112. The opening 112 may be located directly below the valve core 12 so that the valve core 12 can be lowered to block the opening 112. When the valve core 12 is raised, the bottom of the valve core 12 separates from the opening 112 to open the opening 112.

Optionally, in order to ensure that the valve core 12 can completely seal the opening 112 when the valve core 12 blocks the opening 112, an opening sealing member 13 may be further included. The opening sealing member 13 may be provided on the outer side wall near the bottom of the valve core 12 and/or the on the inner side wall of the opening 112. In the separated state, the bottom of the valve core 12 is inserted into the opening 112 to press the opening sealing member 13 to seal the opening 112. Therefore, it can be ensured that when the valve body 10 and the valve base 20 are in a separated state (as shown in FIGS. 1 to 3), that is, before the water tank is installed on an external device, the valve body 10 is kept in a sealed state so that the water tank does not leak.

Optionally, the valve base 20 may include a docking portion 22 for docking with the valve body 10 and an access portion 23 for connecting with the spraying system of an external device. The docking portion 22 contains an accommodating cavity 22a for accommodating the valve body 10. In the docked state, the valve body 10 is inserted into the accommodating cavity 22a. An access cavity 23a is formed in the access portion 23. Furthermore, the outer side wall of the housing 11 of the valve body 10 and/or the inner cavity wall of the accommodating cavity 22a may be provided with a valve body sealing member 15. In the docked state, the side wall of the housing 11 of the valve body 10 and the cavity wall of the accommodating cavity 22a are axially sealed by the valve body sealing member 15. By providing the valve body sealing member 15, the liquid can be prevented from flowing out of the gap between the valve body 10 and the valve base 20. In one embodiment, the valve body sealing member 15 may include a plurality of sealing rings arranged at intervals. Compared to a large complete sealing ring, a plurality of sealing rings arranged at intervals can ensure the sealing effect while the frictional resistance applied during the insertion of the valve body 10 into the valve base 20 is relatively small and accordingly does not negatively affect the insertion of the valve body 10 into the valve base 20.

Optionally, the driving portion 21 on the valve base 20 may be a protrusion formed on the valve base 20 and protruding toward the docking portion 22. The driving portion 21 may be provided with a base connection channel 24 for connecting the accommodating cavity 22a and the access cavity 23a. The accommodating cavity 22a, the base connection channel 24 and the access cavity 23a are connected to form a second fluid channel 211. When the valve body 10 and the valve base 20 are in a docked state (as shown in FIGS. 4 to 6), the driving portion 21 presses against the valve core 12 so that the valve core 12 opens the opening 112. As such, the first fluid channel 111 and the second fluid channel 211 are connected so that the water tank is connected with other pipelines of the spraying system. For example, the water tank forms a passage with the water pump through the pipelines so that the water tank can supply water to the pumping mechanism such as the water pump of the spray system.

Optionally, the sliding direction of the valve core 12 can be consistent with the direction of force applied by the driving portion 21, so that all the force applied by the driving portion 21 is used for the valve core 12 to open the opening 112. In addition, the valve core 12 and the driving portion 21 can be arranged in the vertical direction. As such, ineffective space occupied in the lateral direction is small, which can effectively reduce the volume of the valve body assembly.

Optionally, the valve body 10 is inserted downward into the valve base 20 so that the valve body 10 and the valve base 20 are in a docked state. As a result, the valve body 10 and the valve base 20 can switch between the docked state and the separated state by pulling up and plugging down. Such design is convenient for applying force, conforms to the user's operating habits, and is convenient for operation. Of course, in other optional embodiments, the valve body 10 may also be connected to the valve base 20 by means of horizontal insertion or lateral insertion, which is not limited in the present disclosure.

In the valve body assembly provided in some embodiments, an opening is provided at the bottom of the valve body housing. The opening is used to connect the valve body and the valve base. The valve core in the valve body is used to open or seal the opening. The driving portion is used to drive the valve core to open the opening when the valve body and the valve base are in a docked state. The valve core seals the opening when the valve body and the valve base are in a separated state. Since the opening is arranged at the bottom of the valve body housing, there is no air-trapping cavity between the valve body and the valve base. Once the bottom of the valve body is in contact with the valve base, the opening is opened and the entire valve body assembly is connected so that there is no trapped air in the valve body assembly. Accordingly, there is no need to use a water pump to pump air, thereby greatly improving the efficiency of spraying operations.

Among them, the terms “up”, “down”, etc., are used to describe relative positional relationship of the various structures in the drawings, which are only for ease of description and are not used to limit the scope of the embodiments of the present disclosure. The change or adjustment of the relative relationship shall also be regarded as the applicable scope of the present disclosure without substantial change in the technical content.

In one embodiment, the top of the valve core 12 and/or the bottom of the valve core 12 are provided with a sliding limit portion respectively, which is used to cooperate with the edge of the guide channel of the valve core mounting portion 11d to limit extreme sliding positions of the valve core 12. The top of the valve core 12 may be provided with a sliding limit portion, or the bottom of the valve core 12 may be provided with a sliding limit portion, or both the top and bottom of the valve core 12 may be provided with a sliding limit portion respectively. In one embodiment, sliding limit portions are provided on the top and bottom of the valve core 12 respectively. The sliding limit portion may be a flange projecting radially outward from the top or bottom of the valve core 12. The size of the flange is larger than the size of the guide channel so that the guide channel cannot allow the flange to pass through, thereby achieving the purpose of sliding limit. Optionally, an upper sliding limit portion 121a can be formed on the top of the valve core 12, and a lower sliding limit portion 121b can be formed on the bottom of the valve core 12, Therefore, during the sliding process of the valve core 12, no matter it is upward or downward, the valve core 12 will not escape from the guide channel, which effectively guarantees the reliability of the valve body assembly.

Optionally, the top of the valve core 12 is formed with an elastic expansion portion 121c that can expand and contract along the radial direction of the valve core 12. The radial dimension of the elastic expansion portion 121c after contraction is smaller than the radial dimension of the guide channel. By providing the elastic expansion portion 121c, the upper sliding limiting portion 121a on the top of the valve core 12 can be contracted so that the upper sliding limiting portion 121a can pass through the guide channel. As such, the valve core 12 can escape downward along the guide channel, thereby facilitating removal of the valve core 12 from the housing 11 for replacement or maintenance of the valve core 12.

Optionally, the elastic expansion portion 121c may at least include a first section 1211 and a second section 1212, each extending along the length of the valve core 12 at the top of the valve core 12. There is a preset spacing between the first section 1211 and the second section 1212, and the first section 1211 and/or the second section 1212 have elasticity. At least one of the first section 1211 and the second section 1212 may be an elastic plastic or metal shrapnel. Alternatively, at least an elastic portion may be included in the first section 1211 and the second section 1212 so that the first section 1211 and/or the second section 1212 have elasticity. In one embodiment, the bottoms of the first section 1211 and/or the second section are connected to the valve core 12 through an elastic member such as rubber. Of course, there are many ways to make the first section 1211 and/or the second section 1212 elastic, which are not repeated here.

The first section 1211 and/or the second section 1212 have elasticity. As such, the elastic expansion portion 121c can be contracted in the radial direction so that the valve core 12 can escape downward out of the valve core mounting portion 11d.

In one embodiment, as shown in FIG. 3, the opening 112 may include a reaming section 1121. The diameter of the aperture of the reaming section 1121 gradually increases from the bottom to the top. In the separated state, the opening sealing member 13 is squeezed between the reaming section 1121 and the outer side wall near the bottom of the valve core 13.

Optionally, the opening sealing member 13 may be a rubber sealing ring. The opening sealing member 13 may be provided on the outer side wall near the bottom of the valve core 12, and specifically may be provided on the outer side wall of the lower sliding limit portion 121b. The reaming section 1121 can be used to contact the opening sealing member 13. When the valve core 12 falls downward, the reaming section 1121 can be used to guide the opening sealing member 13 to fall downward, and gradually squeeze the opening sealing member 13 so that the opening sealing member 13 can seal the opening 112 well.

Optionally, the opening sealing member 13 may include a fixing portion 131 and a squeezing portion 132. The fixing portion 131 may be fixed to one of the outer side wall near the bottom of the valve core 12 or the inner side wall of the opening 112. The squeezing portion 132 can be used for squeezing contact with the other one of the outer side wall near the bottom of the valve core 12 or the inner side wall of the opening 112. An outer profile of a cross section of the squeezing portion 132 in a plane parallel to the length direction of the valve core is a curved surface. The opening sealing member 13 may be embedded and fixed on the outer side wall of the valve core 12 or the side wall of the opening 112 through the fixing portion 131. Accordingly, the connection stability is good. The outer profile of the cross-section of the squeezing portion 132 is a curve surface, which enables the opening sealing member 13 to be in point contact with the reaming section 1121. Such design makes the friction force applied by the opening sealing member 13 smaller when the valve core 12 falls downward. As such, the drop resistance of the valve core 12 is smaller so that the valve core 12 can fall to a deeper position. Accordingly, the opening sealing member 13 may tightly seal the opening and improve the sealing degree of the opening 112. This may improve the sealing performance before the water tank is installed in the spray system.

In one embodiment, as shown in FIG. 3 or FIG. 6, the valve body 10 may also be provided with a reset elastic member 14. The reset elastic member 14 can be used to drive the valve core 12 to slide toward the opening 112 until the valve core 12 seals the opening. An elastic force can be applied by the reset elastic member 14 so that the valve core 12 can more tightly seal the opening 112, thereby improving the sealing performance.

Optionally, the reset elastic member 14 can be an axial expansion and contraction spring, or an elastic rubber, etc. The reset elastic member 14 may be sleeved on the outside of the valve core 12. Taking the axis of the valve core 12 as the telescopic axis, the valve core 12 can guide the reset elastic member 14. In addition, as an optional method, the reset elastic member 14 may be located beside the valve core, and the expansion and contraction direction of the reset elastic member 14 is consistent with the sliding direction of the valve core 12. At this time, preferably, the number of the reset elastic members 14 may be multiple. In one embodiment, a plurality of reset elastic members 14 may be evenly distributed in the circumferential direction of the valve core 12 so that the reset elastic members 14 can provide the valve core 12 with a more balanced force.

Optionally, one end of the reset elastic member 14 may be connected to the valve core 12, and the other end of the reset elastic member 14 may be fixed on the housing 11. Specifically, the other end may be fixed on the valve core mounting portion 121a. Alternatively, one end of the reset elastic member 14 may be connected to the valve core 12, and the other end of the reset elastic member 14 may abut against the housing 11 such as the valve core mounting portion 121a. Alternatively, one end of the reset elastic member 14 may abut against the valve core 12, and the other end of the reset elastic member 14 may be connected to the housing 11 such as the valve core mounting portion 121a. These embodiments do not limit the connection and fixing manner of the reset elastic member 14, as long as the reset elastic member 14 can provide an elastic restoring force to the valve core 12. As such, when the valve body 10 is separating from the valve base 20 in a separated state, the valve core 12 can extend into the opening 112 under the action of the elastic restoring force of the reset elastic member 14, thereby sealing the opening.

The specific working process according to one embodiment of the present disclosure is as follows: during the docking process of the valve body 10 and the valve base 20, the reset elastic member 14 deforms and stores elastic potential energy. Once the valve body 10 is separated from the valve base 20, the reset elastic member 14 drives the valve core 12 to move to seal the opening 112 during the process of recovering deformation.

One embodiment of the present disclosure provides a spraying system, including a water tank, a water pump set, and a valve body assembly. As shown in FIGS. 1 to 6, the valve body assembly may include a valve body 10 and a valve base 20. The relative state of the valve body 10 and the valve base 20 includes a docked state and a separated state. The first fluid channel of the valve body 10 may connect with one of the water tank or the water pump set, and the second fluid channel of the valve base 20 may connect with the other one of the water tank or the water pump set.

Optionally, the valve body 10 includes a housing 11 and a valve core 12. A first fluid channel 111 is formed in the housing 11. The valve core 12 is movably arranged in the housing 11, and the bottom of the housing 11 has an opening 112. The valve core 12 can move relative to the housing 11 to seal or open the opening 112. The valve base 20 is provided with a driving portion 21, and a second fluid channel 211 is formed in the valve base 20. In the docked state, the driving portion 21 presses against the valve core 12 to make the valve core 12 open the opening 112. As such, the first fluid channel 111 is connected to the second fluid channel 211. In the separated state, the valve core 12 seals the opening 112.

Optionally, the housing 11 of the valve body 10 may include an upper housing 11a and a lower housing 11b. The upper housing 11a and the lower housing 11b enclose a cavity 11c. The upper housing 11a and the lower housing 11b can be detachably connected. For example, the upper housing 11a and the lower housing 11b may be screwed together. In one embodiment, the upper housing 11a has external threads, the lower housing 11b has internal threads, and the upper housing 11a is inserted into the lower housing 11b and screwed together. Of course, the reverse is also possible, with internal threads on the upper housing 11a and external threads on the lower housing 11b, and the lower housing 11b is inserted into the upper housing 11a and screwed together. In these embodiments, the upper housing 11a and the lower housing 11b are detachably connected, which can facilitate the removal of the valve core 12 from the housing, for example, for installation and maintenance of the valve core 12.

Optionally, in the cavity 11c of the housing 11, there is provided a valve core mounting portion 11d for mounting the valve core 12. The valve core mounting portion 11d can be fixed in the housing 11, and the valve core mounting portion 12 can be formed with a guide channel for valve core 12 to slide so that the valve core 12 can slide in a predetermined direction. In one embodiment, the inner side wall of the lower housing 11b is provided with a support platform 111b protruding toward the inside of the housing 11b for supporting the valve core mounting portion 11d. The valve core mounting portion 11d is provided with an outwardly projecting flange 111d supported on the support platform 111b. The flange 111d is supported on the support platform 111b to support the valve core mounting portion 11d on the housing 11. The valve core mounting portion 11d may be fixed in the housing 11 in an interference fit manner or with fasteners.

Optionally, the valve core mounting portion 11d can divide the cavity 11c into an upper cavity 111c and a lower cavity 112c. The valve core mounting portion 11d also has a valve body connection channel 113c for connecting the upper cavity 111c and the lower cavity 112c. The upper cavity 111c, the valve body connection channel 113c, and the lower cavity 112c form the first fluid channel 111.

Optionally, between the upper housing 11a and the lower housing 11b is provided an upper and lower housing sealing member 11e for at least axially sealing the upper housing 11a and the lower housing 11b. In one embodiment, the upper and lower housing sealing member 11e can be squeezed between the bottom end of the side wall of the upper housing 11a and the supporting platform 111b. When the upper housing 11a is inserted into the lower housing 11b and is tightened by the thread between the upper housing 11a and the lower housing 11b, the bottom end of the side wall of the upper housing 11a exerts a resisting force on the upper and lower housing sealing member 11e. As such, the upper and lower housing sealing member 11e is elastically deformed and fully seals the gap between the upper housing 11a and the lower housing 11b, thereby preventing liquid from flowing into the gap between the upper housing 11a and the lower housing 11b.

Optionally, the valve core 12 can be slidably arranged in the housing 11. In one embodiment, the valve core 12 can be arranged in the valve core mounting portion 11d, and can be raised and lowered in the valve core mounting portion 11d. Of course, it can be understood that the valve core 12 is not limited to moving up and down in the vertical direction. The valve core 12 can also be moved in other ways in the valve core mounting portion 11d. For example, the valve core 12 can be installed in the housing 11 laterally or diagonally, and move along the lateral or diagonal direction, as long as the valve core 12 can block and open the opening 112, which is not limited in this embodiment. In one embodiment, for the convenience of processing and design, the movement direction of the valve core 12 can be restricted to up and down.

The lower housing 11b may include a first side wall 112b for connecting with the upper housing 11a, a second side wall 113b for docking with the valve base 20, and a bottom wall 114b between the second side wall 113b at the bottom of the lower housing 11b. There may be an opening 112 on the bottom wall 114b. The opening 112 may be located directly below the valve core 12, so that the valve core 12 can be lowered to block the opening 112. When the valve core 12 is raised, the bottom of the valve core 12 separates from the opening 112 and thus opens the opening 112.

Optionally, in order to ensure that the valve core 12 can completely seal the opening 112 when the valve core 12 blocks the opening 112, an opening sealing member 13 may be further provided. The opening sealing member 13 may be provided on the outer side wall near the bottom of the valve core 12 and/or on the inner side wall of the opening 112. In the separated state, the bottom of the valve core 12 is inserted into the opening 112 to press the opening sealing member 13 to seal the opening 112. This can ensure that when the valve body 10 and the valve base 20 are in a separated state (as shown in FIGS. 1 to 3), that is, before the water tank is installed on an external device, the valve body 10 is kept in a sealed state so that the water tank does not leak.

The valve base 20 may include a docking portion 22 for docking with the valve body 10 and an access portion 23 for connecting with the spraying system of an external device. The docking portion 22 may include an accommodating cavity 22a for accommodating the valve body 10. In the docked state, the valve body 10 is inserted into the accommodating cavity 22a. An access cavity 23a is formed in the access portion 23. Furthermore, the outer side wall of the housing 11 of the valve body 10 and/or the inner cavity wall of the accommodating cavity 22a may be provided with a valve body sealing member 15. In the docked state, the side wall of the housing 11 of the valve body 10 and the cavity wall of the accommodating cavity 22a are axially sealed by the valve body sealing member 15. By providing the valve body sealing member 15, the liquid can be prevented from flowing out of the gap between the valve body 10 and the valve base 20. Optionally, the valve body sealing member 15 may include a plurality of sealing rings arranged at intervals. Compared with a large complete sealing ring, a plurality of sealing rings arranged at intervals can ensure the sealing effect and, at the same time, the frictional resistance applied during the insertion of the valve body 10 into the valve base 20 is smaller. Thus, the valve body sealing member 15 does not affect the valve body 10 being inserted into the valve base 20.

The driving portion 21 on the valve base 20 may be a protrusion formed on the valve base 20 and protruding toward the docking portion 22. The driving portion 21 may be provided with a base connection channel 24 for connecting the accommodating cavity 22a and the access cavity 23a. The accommodating cavity 22a, the base connection channel 24 and the access cavity 23a are connected to form a second fluid channel 211. When the valve body 10 and the valve base 20 are in a docked state (as shown in FIGS. 4 to 5), the driving portion 21 presses against the valve core 12 so that the valve core 12 opens the opening 112. Then, the first fluid channel 111 and the second circulation channel 211 are connected so that the water tank is connected to other pipelines of the spraying system. For example, the water tank may form a passage with the water pump through the pipelines so that the water tank can supply water to the pumping mechanism such as the water pump of the spraying system.

Optionally, the sliding direction of the valve core 12 can be consistent with the direction of force applied by the driving portion 21, so that all the force applied by the driving portion 21 is used for the valve core 12 to open the opening 112. In addition, the valve core 12 and the driving portion 21 can be arranged in the vertical direction. As such, ineffective space occupied in the lateral direction is small, which can effectively reduce the volume of the valve body assembly.

Optionally, the valve body 10 is inserted downward into the valve base 20 so that the valve body 10 and the valve base 20 are in a docked state. As a result, the valve body 10 and the valve base 20 can switch between the docked state and the separated state by pulling up and plugging down. Such design is convenient for applying force, conforms to the user's operating habits, and is convenient for operation. Of course, in other optional embodiments, the valve body 10 may also be connected to the valve base 20 by means of horizontal insertion or lateral insertion, which is not limited in the present disclosure.

The spraying system according to one embodiment of the present disclosure may provide an opening at the bottom of the valve body. The opening may be used to connect the valve body and the valve base. The valve core in the valve body may be used to open or seal the opening. The driving portion on the valve base may be used to drive the valve core to open the opening when the valve body and the valve base are in a docked state. The valve core seals the opening when the valve body and the valve base are in a separated state. Since the opening is arranged at the bottom of the valve body housing, there is no air trapping cavity between the valve body and the valve base. Once the bottom of the valve body is in contact with the valve base, the opening is opened and the entire valve body assembly is connected so that there is no trapped air in the valve body assembly. Accordingly, there is no need to use a water pump to pump air, and the efficiency of spraying operation may be improved greatly.

In one embodiment, the top of the valve core 12 and/or the bottom of the valve core 12 are provided with a sliding limit portion respectively. The sliding limit portion may be used to cooperate with the edge of the guide channel of the valve core mounting portion 11d to limit the extreme sliding position of the valve core 12. Further, the top of the valve core 12 may be formed with an elastic expansion portion 121c that can expand and contract along the radial direction of the valve core 12. The radial dimension of the elastic expansion portion 121c after contraction may be smaller than the radial dimension of the guide channel. Optionally, the elastic expansion portion 121c may at least include a first section 1211 and a second section 1212, each extending along the length of the valve core 12 at the top of the valve core 12. There is a preset spacing between the first section 1211 and the second section 1212. Furthermore, the first section 1211 and/or the second section 1212 have elasticity.

In one embodiment, as shown in FIG. 3, the opening 112 may include a reaming section 1121. A diameter of an aperture of the reaming section 1121 gradually increases from the bottom to the top. In the separated state, the opening sealing member 13 is squeezed between the reaming section 1121 and the outer side wall near the bottom of the valve core 13.

Optionally, the opening sealing member 13 may include a fixing portion 131 and a squeezing portion 132. The fixing portion 131 may be fixed to one of the outer side wall near the bottom of the valve core 12 or the inner side wall of the opening 112. The squeezing portion 132 can be used for squeezing contact with the other one of the outer side wall near the bottom of the valve core 12 or the inner side wall of the opening 112. The outer profile of the cross section of the squeezing portion 132 in a plane parallel to the length direction of the valve core is a curved surface.

In one embodiment, as shown in FIG. 3 or FIG. 6, the valve body 10 may also be provided with a reset elastic member 14. The reset elastic member 14 can be used to drive the valve core 12 to slide toward the opening 112 until the valve core 12 seals the opening. Optionally, the reset elastic member 14 is located beside the valve core, and the expansion and contraction direction of the reset elastic member 14 is consistent with the sliding direction of the valve core 12.

One embodiment of this present disclosure provides an unmanned aerial vehicle (UAV). The UAV may include a frame and a spraying system. The spraying system may include a water tank, a water pump set, and a valve body assembly. As shown in FIGS. 1 to 6, the valve body assembly may include a valve body 10 and a valve base 20. The relative state of the valve body 10 and the valve base 20 includes a docked state and a separated state. The first fluid channel of the valve body 10 connects with one of the water tank or the water pump set, and the second fluid channel of the valve base 20 connects with the other one of the water tank or the water pump set.

The valve body 10 may include a housing and a valve core. A first fluid channel may be formed in the housing. The valve core may be movably arranged in the housing and has an opening at the bottom of the housing. The valve core can move relative to the housing to seal or open the opening.

Optionally, a driving portion may be provided on the valve base, and a second fluid channel may be formed in the valve base. In the docked state, the driving portion presses against the valve core so that the valve core opens the opening. As such, the first fluid channel connects to the second fluid channel. In the separated state, the valve core seals the opening.

Optionally, the valve body 10 includes a housing 11 and a valve core 12. A first fluid channel 111 may be formed in the housing 11. The valve core 12 may be movably arranged in the housing 11, and the bottom of the housing 11 may have an opening 112. The valve core 12 can move relative to the housing 11 to seal or open the opening 112. The valve base 20 may be provided with a driving portion 21, and a second fluid channel 211 may be formed in the valve base 20. In the docked state, the driving portion 21 may press against the valve core 12 to make the valve core 12 to open the opening 112. Accordingly, the first fluid channel 111 is connected to the second fluid Channel 211. In the separated state, the valve core 12 seals the opening 112.

Optionally, the housing 11 of the valve body 10 may include an upper housing 11a and a lower housing 11b. The upper housing 11a and the lower housing 11b enclose a cavity 11c. The upper housing 11a and the lower housing 11b can be detachably connected. For example, the upper housing 11a and the lower housing 11b may be screwed together. The upper housing 11a has external threads, the lower housing 11b has internal threads, and the upper housing 11a is inserted into the lower housing 11b and screwed together. Of course, the reverse is also possible, with internal threads on the upper housing 11a and external threads on the lower housing 11b. Then, the lower housing 11b is inserted into the upper housing 11a and screwed together. In these embodiments, the upper housing 11a and the lower housing 11b are detachably connected. Such design can facilitate the removal of the valve core 12, for example, for the installation and maintenance of the valve core 12.

Optionally, in the cavity 11c of the housing 11, there is provided a valve core mounting portion 11d for mounting the valve core 12. The valve core mounting portion 11d can be fixed in the housing 11, and the valve core mounting portion 12 can be formed with a guide channel for the valve core 12 to slide so that the valve core 12 can slide in a predetermined direction. The inner side wall of the lower housing 11b is provided with a support platform 111b protruding toward the inside of the housing 11b for supporting the valve core mounting portion 11d. The valve core mounting portion 11d is provided with an outwardly projecting flange 111d supported on the support platform 111b. The flange 111d is supported on the support platform 111b to support the valve core mounting portion 11d on the housing 11. The valve core mounting portion 11d may be fixed in the housing 11 in an interference fit manner or with fasteners.

The valve core mounting portion 11d may divide the cavity 11c into an upper cavity 111c and a lower cavity 112c. The valve core mounting portion 11d may also have a valve body connection channel 113c for connecting the upper cavity 111c and the lower cavity 112c. The upper cavity 111c, the valve body connection channel 113c, and the lower cavity 112c may form the first fluid channel 111.

Optionally, between the upper housing 11a and the lower housing 11b is provided an upper and lower housing sealing member 11e for at least axially sealing the upper housing 11a and the lower housing 11b. In one embodiment, the upper and lower housing sealing member 11e can be squeezed between the side wall at the bottom end of the upper housing 11a and the supporting platform 111b. During the tightening process, the side wall at the bottom end of the upper housing 11a exerts a pressing force on the upper and lower shell sealing member 11e. As such, the upper and lower shell sealing member 11e is elastically deformed and fully seal the gap between the upper housing 11a and the lower housing 11b, thereby preventing liquid from flowing into the gap between the upper housing 11a and the lower housing 11b.

Optionally, the valve core 12 can be slidably arranged in the housing 11. In one embodiment, the valve core 12 can be arranged in the valve core mounting portion 11d, and can be raised and lowered in the valve core mounting portion 11d. Of course, it can be understood that the valve core 12 is not limited to moving up and down in the vertical direction. The valve core 12 can also be moved in other ways in the valve core mounting portion 11d. In one embodiment, the valve core 12 can be installed in the housing 11 laterally or diagonally, and move along the lateral or diagonal direction, as long as the valve core 12 can block and open the opening 112. In one embodiment, for the convenience of processing and design, the movement direction of the valve core 12 can be restricted to up and down.

Optionally, the lower housing 11b may include a first side wall 112b for connecting with the upper housing 11a, a second side wall 113b for docking with the valve base 20, and a bottom wall connecting between the second side walls 113b at the bottom of the lower housing 11b. There may be an opening 112 on the bottom wall 114b. The opening 112 may be located directly below the valve core 12, so that the valve core 12 can be lowered to block the opening 112. When the valve core 12 is raised, the bottom of the valve core 12 separates from the opening 112 and then opens the opening 112.

Optionally, in order to ensure that the valve core 12 can completely seal the opening 112 when the valve core 12 blocks the opening 112, an opening sealing member 13 may be further included. The opening sealing member 13 may be provided on the outer side wall near the bottom of the valve core 12 and/or on the inner side wall of the opening 112. In the separated state, the bottom of the valve core 12 is inserted into the opening 112 to press the opening sealing member 13 to seal the opening 112. Therefore, it can be ensured that when the valve body 10 and the valve base 20 are in a separated state (as shown in FIGS. 1 to 3), that is, before the water tank is installed in an external device, the valve body 10 is kept in a sealed state so that the water tank does not leak.

The valve base 20 may include a docking portion 22 for docking with the valve body 10 and an access portion 23 for connecting with the spraying system of an external device. The docking portion 22 may include an accommodating cavity 22a for accommodating the valve body 10. In the docked state, the valve body 10 may be inserted into the accommodating cavity 22a. An access cavity 23a may be formed in the access portion 23. Furthermore, the outer side wall of the housing 11 of the valve body 10 and/or the inner cavity wall of the accommodating cavity 22a may be provided with a valve body sealing member 15. In the docked state, the side wall of the housing 11 of the valve body 10 and the cavity wall of the accommodating cavity 22a are axially sealed by the valve body sealing member 15. By providing the valve body sealing member 15, the liquid can be prevented from flowing out of the gap between the valve body 10 and the valve base 20. Optionally, the valve body sealing member 15 may include a plurality of sealing rings arranged at intervals. Compared with a large complete sealing ring, a plurality of sealing rings arranged at intervals can ensure the sealing effect and at the same time, the frictional resistance applied during the insertion of the valve body 10 into the valve base 20 is smaller. As such, the valve body sealing member does not affect the valve body 10 being inserted into the valve base 20.

The driving portion 21 on the valve base 20 may be a protrusion formed on the valve base 20 and protruding toward the docking portion 22. The driving portion 21 may be provided with a base connection channel 24 for connecting the accommodating cavity 22a and the access cavity 23a. The accommodating cavity 22a, the base connection channel 24, and the access cavity 23a are connected to form a second fluid channel 211. When the valve body 10 and the valve base 20 are in a docked state (as shown in FIGS. 4 to 5), the driving portion 21 presses against the valve core 12, so that the valve core 12 opens the opening 112. As such, the first fluid channel 111 and the second fluid channel 211 are connected so that the water tank is connected with other pipelines of the spraying system. For example, the water tank may form a passage with the water pump through the pipelines, so that the water tank can supply water to the pumping mechanism such as the water pump of the spray system.

The sliding direction of the valve core 12 may be consistent with the direction of force applied by the driving portion 21, so that all the force applied by the driving part 21 is used for the valve core 12 to open the opening 112. In addition, the valve core 12 and the driving portion 21 can be arranged in the vertical direction. As such, the ineffective space occupied in the lateral direction is small, thereby effectively reducing the volume of the valve body assembly.

In one embodiment, the valve body 10 is inserted downward into the valve base 20 so that the valve body 10 and the valve base 20 are in a docked state. As a result, the valve body 10 and the valve base 20 can switch between the docked state and the separated state by pulling up and plugging down. Such design is convenient for applying force, conforms to the user's operating habits, and is convenient for operation. Of course, in other optional embodiments, the valve body 10 may also be connected to the valve base 20 by means of horizontal insertion or lateral insertion, which is not limited in the present disclosure.

The spraying system provided in one embodiment of the present disclosure provides an opening at the bottom of the valve body. The opening is used to connect the valve body and the valve base, and the valve core in the valve body is used to open or seal the opening. The driving portion on the valve base is used to drive the valve core to open the opening when the valve body and the valve base are in a docked state. The valve core seals the opening when the valve body and the valve base are in a separated state. Since the opening is provided at the bottom of the valve body housing, there is no air trapping cavity between the valve body and the valve base. Once the bottom of the valve body contacts the valve base, the opening is opened and the entire valve body assembly is connected. As such, there is no trapped air in the valve body assembly. Thus, there is no need to pump air with a water pump, thereby greatly improving the efficiency of spraying operation.

In one embodiment, the top of the valve core 12 and/or the bottom of the valve core 12 are provided with a sliding limit portion respectively, which is used to cooperate with the edge of the guide channel of the valve core mounting portion 11d to limit extreme sliding positions of the valve core 12. Further, the top of the valve core 12 is formed with an elastic expansion portion 121c that can expand and contract along the radial direction of the valve core 12. The radial dimension of the elastic expansion portion 121c after contraction may be smaller than the radial dimension of the guide channel. In one embodiment, the elastic expansion portion 121 may at least include a first section 1211 and a second section 1212, each extending along the length direction of the valve core 12 at the top of the valve core 12. There is a preset spacing between the first section 1211 and the second section 1212, and the first section 1211 and/or the second section 1212 have elasticity.

In one embodiment, as shown in FIG. 3, the opening 112 may include a reaming section 1121. The diameter of the aperture of the reaming section 1121 gradually increases from the bottom to the top. In the separated state, the opening sealing member 13 is squeezed between the reaming section 1121 and the outer side wall near the bottom of the valve core 12.

Optionally, the opening sealing member 13 may include a fixing portion 131 and a squeezing portion 132. The fixing portion 131 can be fixed to one of the outer side wall near the bottom of the valve core 12 or the inner side wall of the opening 112. The squeezing portion 132 can be used for squeezing contact with the other one of the outer side wall near the bottom of the valve core 12 or the inner side wall of the opening 112. The outer profile of the cross section of the squeezing portion 132 in a plane parallel to the length direction of the valve core is a curved surface.

In one embodiment, as shown in FIG. 3 or FIG. 6, the valve body 10 may also be provided with a reset elastic member 14. The reset elastic member 14 can be used to drive the valve core 12 to slide toward the opening 112 until the valve core 12 seals the opening. In one embodiment, the reset elastic member 14 is located beside the valve core, and the expansion and contraction direction of the reset elastic member 14 is consistent with the sliding direction of the valve core 12.

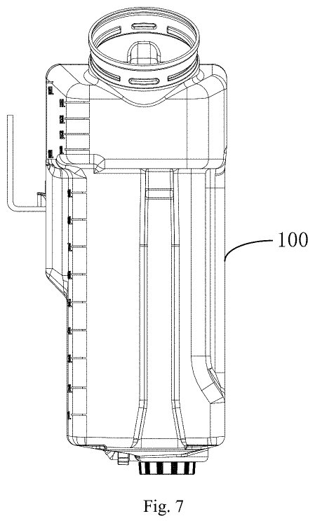

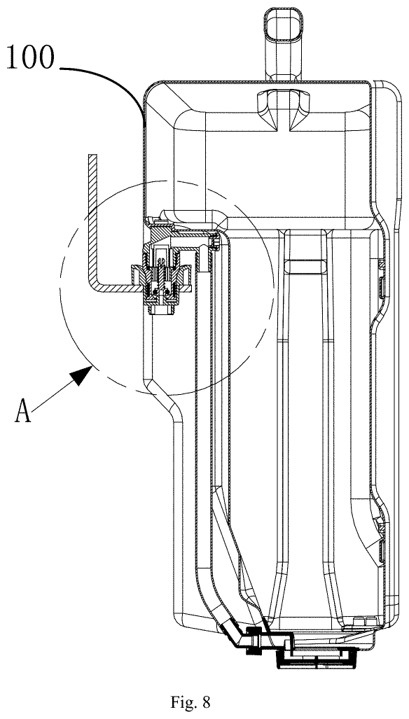

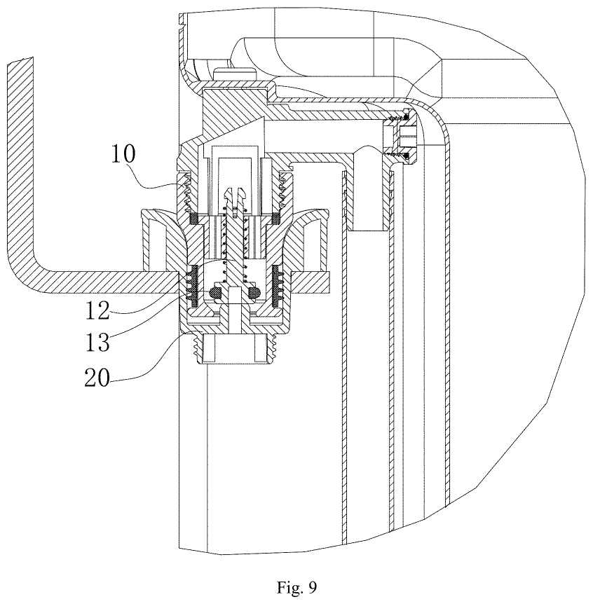

One embodiment of the present disclosure provides a water tank. FIG. 7 is a schematic structural diagram of a water tank provided by an embodiment of the present disclosure. FIG. 8 is a cross-sectional view of a water tank provided by an embodiment of the present disclosure. FIG. 9 is an enlarged view of A in FIG. 8. As shown in FIGS. 1 to 8, the water tank of this embodiment includes a tank body 100 and a valve body 10.

Optionally, the valve body is installed on the tank body 100. The valve body 10 is used to dock with the valve base of the UAV. The relative state of the valve body 10 and the valve base 20 includes a docked state and a separated state.

Optionally, the valve body 10 includes a housing 11 and a valve core 12. A first fluid channel 111 is formed in the housing 11. The valve core 12 is movably arranged in the housing 11, and the bottom of the housing 11 has an opening 112. The valve core 12 can move relative to the housing 11 to seal or open the opening 112. The valve base 20 is provided with a driving portion 21, and a second fluid channel 211 is formed in the valve base 20. In the docked state, the driving portion 21 presses against the valve core 12 to make the valve core 12 to open the opening 11. As such, the first fluid channel 111 is connected to the second fluid channel 211. In the separated state, the valve core 12 seals the opening 112.

One embodiment of the present disclosure provides an unmanned aerial vehicle, including a body and a valve base 20 installed on the body. The valve base 20 is used to dock with the valve body 10 of the water tank. The relative state of the valve body 10 and the valve base 20 includes a docked state and a separated state.

Optionally, the valve body 10 includes a housing 11 and a valve core 12. A first fluid channel 111 is formed in the housing 11. The valve core 12 is movably arranged in the housing 11, and the bottom of the housing 11 has an opening 112. The valve core 12 can move relative to the housing 11 to seal or open the opening 112. The valve base 20 is provided with a driving portion 21, and a second fluid channel 211 is formed in the valve base 20. In the docked state, the driving portion 21 presses against the valve core 12 to make the valve core 12 to open the opening 112. As such, the first fluid channel 111 is connected to the second fluid channel 211. In the separated state, the valve core 12 seals the opening 112.

The principles and the embodiments of the present disclosure are set forth in the specification. The description of the embodiments of the present disclosure is only used to help understand the apparatus and method of the present disclosure and the core idea thereof. Meanwhile, for a person of ordinary skill in the art, the disclosure relates to the scope of the disclosure, and the technical scheme is not limited to the specific combination of the technical features, but also covers other technical schemes which are formed by combining the technical features or the equivalent features of the technical features without departing from the inventive concept. For example, a technical scheme may be obtained by replacing the features described above as disclosed in this disclosure (but not limited to) with similar features.

What is claimed is:

1. A valve body assembly, comprising:
a valve body comprising a housing, a valve core, and a first fluid channel; and
a valve base comprising a driving portion and a second fluid channel,
wherein a bottom of the housing comprises an opening, and the valve core is configured to move relative to the housing to seal the opening in a separated state or open the opening in a docked state.

2. The valve body assembly of claim 1, wherein the valve body is configured to be inserted downwardly into the valve base so that the valve body and the valve base are in the docked state.

3. The valve body assembly of claim 2, wherein in the docked state, the driving portion is configured to press against the valve core so that the valve core opens the opening, thereby connecting the first fluid channel and the second fluid channel.

4. The valve body assembly of claim 3, wherein the valve core is slidably arranged in the housing, and a sliding direction of the valve core is the same as a direction of force on the valve core applied by the driving portion.

5. The valve body assembly of claim 4, wherein a valve core mounting portion is fixed in the housing, and the valve core mounting portion comprises a guide channel for the valve core to be slidably arranged in the housing.

6. The valve body assembly of claim 5, wherein a top of the valve core or a bottom of the valve core is provided with a sliding limit portion, the sliding limit portion is configured to cooperate with an edge of the guide channel of the valve core mounting portion to limit an extreme sliding position of the valve core.

7. The valve body assembly of claim 5, wherein a top of the valve core is provided with an elastic expansion portion capable of expanding and contracting in a radial direction of the valve core, and a radial dimension of the elastic expansion portion after contraction is smaller than a radial dimension of the guide channel.

8. The valve body assembly of claim 7, wherein the elastic expansion portion at the top of the valve core comprises at least a first section and a second section, each extending along a length direction of the valve core, and a spacing between the first section and the second section.

9. The valve body assembly of claim 1, further comprising an opening sealing member on an outer side wall near a bottom of the valve core and/or on an inner side wall of the opening;
wherein in the separated state, the valve core is inserted into the opening to squeeze the opening sealing member to seal the opening.

10. The valve body assembly of claim 9, wherein the opening comprises a reaming section, and a diameter of an aperture of the reaming section gradually increases from a bottom of the reaming section to a top of the reaming section, and in the separated state, the opening sealing member is squeezed between the reaming section and the outer side wall near the bottom of the valve core.

11. The valve body assembly of claim 9, wherein the opening sealing member comprises a fixing portion and a squeezing portion, the fixing portion is fixed on one of the outer side wall near the bottom of the valve core or the inner side wall of the opening, the squeezing portion is configured to have squeezing contact with the other one of the outer side wall near the bottom of the valve core or the inner side wall of the opening, and an outer profile of a cross section of the squeezing portion in a plane parallel to a length direction of the valve core is a curved surface.

12. The valve body assembly of claim 1, wherein the valve body is also provided with a reset elastic member, and the reset elastic member is configured to drive the valve core to slide toward the opening to seal the opening in the separated state.

13. The valve body assembly of claim 12, wherein the reset elastic member is sleeved on an outer side wall of the valve core or located beside the valve core, and the reset elastic member is configured to expand and contract in a same direction as a sliding direction of the valve core.

14. The valve body assembly of claim 1, wherein the housing includes an upper housing and a lower housing, and the upper housing is detachably connected with the lower housing.

15. The valve body assembly of claim 14, wherein an upper and lower housing sealing member is between the upper housing and the lower housing, and the upper and lower housing sealing member is configured to at least axially seal the upper housing and the lower housing.

16. The valve body assembly of claim 1, wherein the valve base comprises an accommodation cavity for accommodating the valve body, and in the docked state, the valve body is inserted into the accommodation cavity.

17. The valve body assembly of claim 16, wherein an outer side wall of the housing of the valve body or an inner cavity wall of the accommodating cavity is provided with a valve body sealing member, and in the docked state, the outer side wall of the housing of the valve body and the inner cavity wall of the accommodating cavity are axially sealed by the valve body sealing member.

18. A water tank, comprising:
a tank body,
a valve body on the tank body; the valve body comprising a housing, a valve core, and a first fluid channel in the housing; an opening at a bottom of the housing, and the valve core configured to move relative to the housing to seal the opening in a separated state or open the opening in a docked state; and
a valve base comprising a driving portion and a second fluid channel.

19. The water tank of claim 18, wherein in the docked state, the driving portion is configured to press against the valve core so that the valve core opens the opening, thereby connecting the first fluid channel and the second fluid channel.

20. An unmanned aerial vehicle, comprising:
a body,
a valve base on the body, the valve base configured to dock with a valve body of a water tank,
the valve body comprising a housing, a valve core, and a first fluid channel in the housing;
an opening at a bottom of the housing, and the valve core configured to move relative to the housing to seal or open the opening;
the valve base comprising a driving portion and a second fluid channel;
wherein in a separated state, the valve core is configured to seal the opening; and
in a docked state, the driving portion is configured to press against the valve core so that the valve core opens the opening, thereby connecting the first fluid channel and the second fluid channel.
